(19) United States
(12) Patent Application Publication
(10) Pub. No.: US 2006/0174120 A1
(43) Pub. Date: Aug. 3, 2006

(54) System and method for providing peer-to-peer communication

(75) Inventors: Lucanus H. Rippy, San Clemente, CA (US); Kenneth J. Reda, Temecula, CA (US); Christopher A. Akins, Griffith, GA (US)

Correspondence Address: CROWELL & MORING LLP;INTELLECTUAL PROPERTY GROUP, P.O. BOX 14300, WASHINGTON, DC, 20044-4300, US

(73) Assignee: SEAMLESS PEER 2 PEER, INC., Las Vegas, NV (US)

(21) Appl. No.: 11/346,966

(22) Filed: Feb. 2, 2006

Related U.S. Application Data
(60) Provisional application No. 60/649,852, filed on Feb. 2, 2005.

(51) Int. Cl. H04L 9/00

(52) U.S. Cl. 713/171

(57) ABSTRACT

User identity is verified using license keys issued during a pre-registration process. In one embodiment, members of a defined community communicate with other members of the community using uniquely identifying PKI keys. In one embodiment, the identity of a user is assured by having a system-level administrator issue license keys and pre-register the user. In one embodiment, during a pre-registration process, a setup server may be accessed to generate a private license key that will be used to secure and encrypt all communication from one user to another.

This application is related to and claims priority from the U.S. provisional patent application having application No. 60/649,852, filed on Feb. 2, 2005.

### CROSS REFERENCE TO RELATED APPLICATIONS

1. Field of the Invention

The present invention relates to peer-to-peer communication, and more particularly to systems and methods for providing peer-to-peer communication using a secure direct pipeline.

2. Background

Peer-to-peer (P2P) technologies have traditionally been employed primarily to share electronic content (i.e., digital files) between multiple users. In particular, P2P technologies enable a single user to query a community of users for specific electronic content. When located, the requesting user's computer system would then connect directly to the target user's computer system (i.e., where the desired content is located), and retrieve a copy of it.

However, P2P technologies has been plagued by several noteworthy drawbacks. For example, existing P2P technology provides only limited control of P2P user access. Namely, it is currently not possible to adequately constrain content access to only specific users and/or enable users to provide assurances as to their identity(s). Moreover, P2P technology suffers from a general lack of security given that any member of the global P2P community may gain access to any number of other computers in the P2P community, regardless of where such computers are located or what they contain. Other security concerns relating to P2P communication include the fact that such communications have been unencrypted and easily traceable, thereby enabling others to readily view, hijack and/or replace them.

In addition, P2P access is susceptible to inadvertent blocking by commonly used security measures, such as network firewalls. Dynamic Network Addressing technologies (e.g., DHCP, NAT, etc.) may also inadvertently constrain direct P2P communication. Thus, there is a need for providing improved systems and methods for P2P communication.

### BRIEF SUMMARY OF THE INVENTION

Systems and methods for providing peer-to-peer communication are disclosed. In one embodiment, a method includes pre-registering an originating user by receiving first user information for the originating user and assigning the originating user a first digital license key. The method further includes receiving a request to send a P2P communication to a destination user, wherein the request is accompanied or associated with second user information and a second digital license key. The method also includes comparing the second user information and second digital license key to the first user information and first digital license key stored during the pre-registration of the originating user, and if there is a match assigning a session key to the originating user usable to authenticate the P2P communication.

Other aspects, features, and techniques of the invention will be apparent to one skilled in the relevant art in view of the following detailed description of the invention.

### BRIEF DESCRIPTION OF THE DRAWINGS

FIG. 1 is a system diagram of one embodiment of a system for carrying out one or more aspects of the invention;

FIG. 2 is one embodiment of a system diagram showing the interconnectivity between the directory server of FIG. 1 and the P2P client of FIG. 1;

FIG. 3 is one embodiment of a system diagram showing how the firewall sever of FIG. 1 may used to facilitate communication through one or more firewalls;

FIG. 4 depicts portions of one embodiment a relational database for implementing one or more aspect of the invention;

FIG. 5 illustrates a process for carrying out user pre-registration in accordance with one embodiment of the invention;

FIG. 6 is a system-level diagram showing the interconnectivity between a P2P server and two users in accordance with one embodiment the invention; and

FIGS. 7A-7B illustrate how certain aspects of the invention may be used to provide secure communication between two users.

### DETAILED DESCRIPTION OF EXEMPLARY EMBODIMENTS

One aspect of the invention relates to providing secure, authenticated peer-to-peer access between defined communities of users. In one embodiment, one or more user-level P2P applications may be used to engage in secure electronic transmission of data using encryption methods and technologies. Such communication may include, for example, instant messaging and chat, voice and video conferencing, file transfer, secure electronic mail, secure website access, remote control of a computer system and/or customizable user interaction, application access, and authentication.

Another aspect of the invention is to verify user identity using license keys issued during a pre-registration process. In one embodiment, members of a defined community will be able to communicate with other members of the community using uniquely identifying PKIs. In one embodiment, the identity of a user is assured by having a system-level administrator issue license keys and pre-register the user. In one embodiment, during a pre-registration process, a setup server may be accessed to generate a private license key that will be used to secure and encrypt all communication from one user to another.

A software application/client resident on a user computer may be used to implement one or more aspects of the invention. This application/client may be used to enable each of the plurality of user computers to communicate with the other computers via an encrypted pipeline. In one embodiment, communication may be encrypted with a public key encryption system (e.g., between 64-bit to over 2048-bit), which may be Rijndael/AES encryption with a scalable key set. In another embodiment, users may be assured that they are communicating with the expected party because they are uniquely identified using a public key infrastructure (PKI). Public keys may be passed using a central P2P server. While a different private key/public key pair may be generated for each user, in another embodiment a different private key/public key pair may be generated for each P2P communication. It should be appreciated that the encryption mode may be Rijndael, Advanced Encryption Standard or any other encryption mode.

In one embodiment, one or more P2P plug-ins on a user computer may be used to initiate various P2P communications such as file access, remote control, instant Messaging, etc. A DLL-architecture may be used to allow other applications to plug into a client-side P2P application without having to recompile the code. In this fashion, the DLL on one P2P client (e.g., user computer) may communicate with the DLLs on other P2P clients through the above encrypted pipeline.

Another aspect is to use a switchboard-type architecture to enable P2P users to find each other. This architecture may be comprised of a thin server which maintains user information, IP addresses, and encryption information. In one embodiment, this server enables P2P users to search for other P2P users via a directory instead of having to know IP addresses and/or encryption keys.

Still another aspect of the invention is to enable P2P users to define their own customized community comprised of other P2P users with whom they will engage in P2P activities and capabilities. Using the ability to create customized user communities, users can create controlled, secure Virtual Private Networks (VPNs) that span internal and external networks without the concern of compromising sensitive data. Some examples of applications for specific VPNs may include, but not be limited to, the healthcare industry, manufacturing and law enforcement. In the case of healthcare, healthcare providers would be able to share sensitive patient information with each other and insurance providers, while maintaining complete HIPPA compliance. Manufacturing companies may be able to extend their existing resource planning software applications to securely communicate with their suppliers, vendors, and customers. Similarly, law enforcement organizations can securely share information at multiple levels of government in a secure and controlled environment and across networks and network types (e.g. closed, wireless, etc).

One or more aspects of the invention may be implemented using an Application Programming Interface (API) that allows for the rapid development of P2P applications that use the same core technologies including user communities, encryption, network tunneling, user authentication, etc.

One or more of the aforementioned aspects may be implemented across Local Area Networks and Wide Area Networks (LAN/WAN), WiFi (wireless) networks, MESH networks (including serverless environments), and any other TCP/IP enabled network technology.

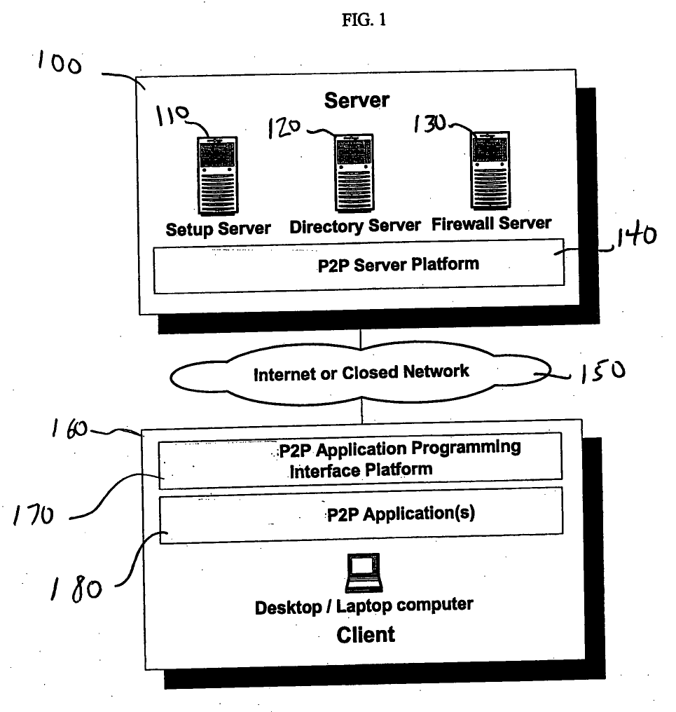

Referring now to FIG. 1, depicted is one embodiment of a P2P server capable of carrying out one or more aspects of the invention. In this embodiment server 100 is comprised of a setup server 110, a directory server 120, a firewall server 130 and a P2P server platform 140 for communicating across network 150. In one embodiment, the setup Server 110 may be accessed during an installation process to generate the private key that will be used to secure and encrypt all communication from one user to another. In one embodiment, each user may be given a computer generated “private key” when they register their P2P client with the setup server 110. This private key is unique to the user and may be used to encrypt all data transmissions. Since no two users will have the same private key, in one embodiment all electronic transmissions of data for a given user will be unique to the user performing the transmission.

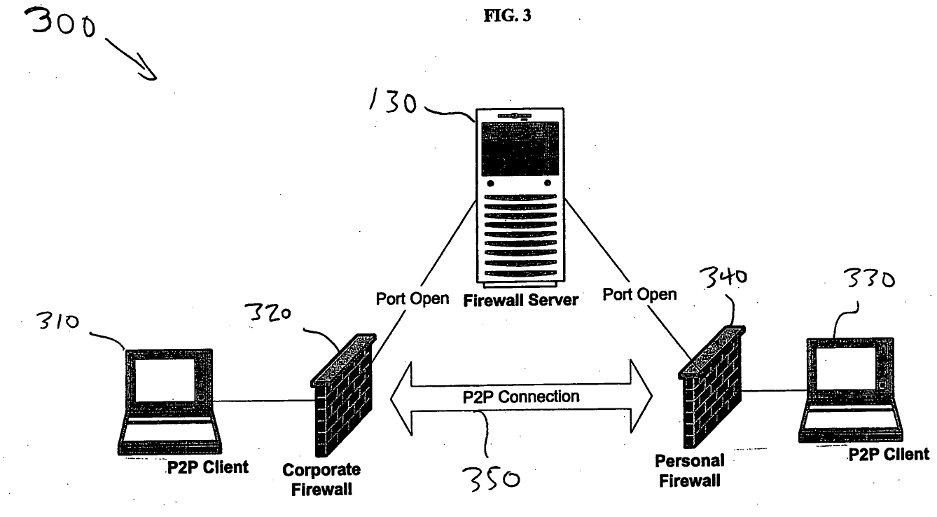

The directory server 120, on the other hand, may be used each time a user initiates/executes a P2P application. The directory server 120 may be used to authenticate the user, as well as those in the user's selected community of approved users (e.g., those users with whom P2P communication/access is to be allowed). The directory server 120 may also be used to lookup other P2P users (i.e., not in the selected community) with the intent of adding them as a trusted member of the user's community. As will be described in more detail below with reference to FIG. 3, the firewall server 130 may be used to initiate P2P communication between P2P applications running behind a firewall.

The P2P server platform 140 may be comprised of one or more software layers used to interface server 100 with client-side system 160 over network 150. On the client-side, a P2P API software platform 170 may be used to interface the client-side P2P application 180 with the server 100.

It should be appreciated that the invention may be implemented across Local Area Networks and Wide Area Networks (LAN/WAN), WiFi (wireless) networks, MESH networks (including serverless environments), and any other TCP/IP enabled network technology. In another embodiment, the invention may accommodate dynamic and static IP addressing, as well as Network Address Translation (NAT) technologies.

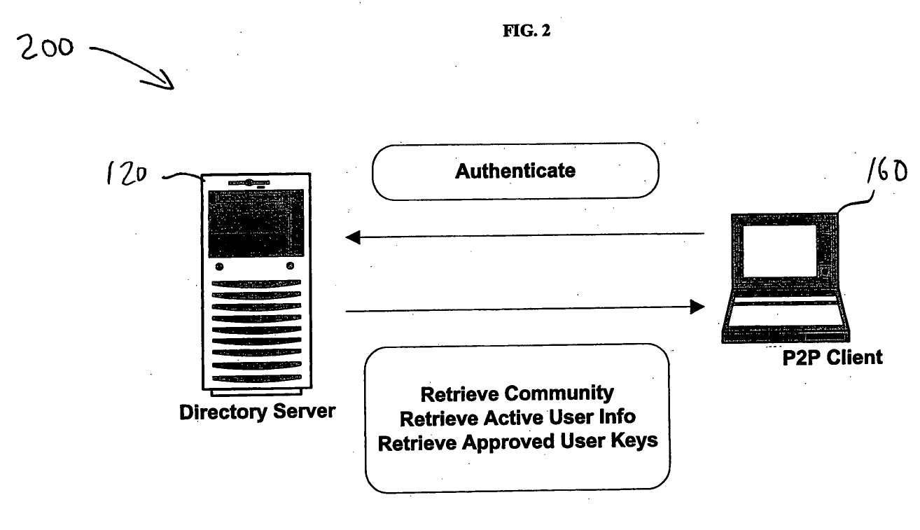

Referring now to FIG. 2, depicted is a system 200 for how a client-side system 160 may interact with the directory server 120. In this embodiment, the client 160 may be authenticated by directory server 120, which may be done using any number of authentication protocols. Once authenticated, the client-side system 160 may retrieve the community of trusted users (e.g., those matching one or more user-defined criteria), the user information for those trusted users, and the approved public encryption key(s) of those trusted user. In this fashion, client-side system 160 may then engage in P2P communication with only its specified community of users. Such a private network may then enable direct communication with specified peers, the addition or deletion of peers at any time (including during a session), assigning permission-based levels for file sharing, voice, etc., and/or location of possible peer additions by email address, name and/or nickname.

Continuing to refer to FIG. 2, location of the individuals which comprise the community is achieved through the directory server 120. In this embodiment, a global server (e.g., directory server 120) contains a list of all registered users (i.e., potential peers of a user's private network). This database may contain the last known locations (either online or offline) of all users (e.g., their IP addresses including DHCP/NAT information). In this fashion, directory server 120 may be used as a global lookup database of all registered users from which to initially locate other users to add to the user's private network. The server is then accessed each time you open your P2P network.

In one embodiment, the addition of a user to a private network may proceed as follows:
1. User A finds User B using just an email address or name using a global lookup database.
2. User A requests to add User B to his private network.
3. User B accepts and a private key is given to User A. In turn, User B is given User A's private key.
4. Next time User A initiates the P2P client 170, a request is made of the directory server 120 for the last known IP address information for all users in his private network.
5. A P2P connection is attempted with User B based on his last known IP information. If User B is online, the connection is completed and both are notified that they are online.
6. User A and User B can now communicate through the secure P2P pipeline wherein all transmissions are encrypted using their public/private key pairs.

Note that in the aforementioned example, the directory server 120 is accessed only to get the last known valid IP information for each user in the private network. Once that request has been completed, no further server communication is required and direct P2P encrypted communication may follow.

Another example of how the addition of a user to a private network may proceed is as follows. In this example, a local user server which is available within the network/extranet is used to obtain user information.
1. User A and User B have a predefined relationship (as defined by an administrator) and have each other's private key information.
2. When User A opens their client side P2P application 170 a request is made of a local user server for the last known IP address information for all users in his private network.
3. A P2P connection is attempted with User B (and all other users) based on his last known IP information. If User B is online, the connection is completed and both are notified that they are online.
4. User A and User B can now communicate through the secure P2P pipeline with all transmissions being encrypted as before.

It should equally be appreciated that a completely server-less environment is also possible by using local cache information, which can be maintained through a separate administration system and managed by a system administrator.

Referring now to FIG. 3, depicted is a P2P system 300 in which a firewall server 130 is used to establish a secure pipeline of direct communication from one user computer to another, where one or both of the user computers reside behind firewalls. As shown in FIG. 3, P2P client system 310 resides behind firewall 320, while P2P client system 330 resides behind firewall 340. Traditionally, direct P2P communication would not be possible in this case since P2P communication requires port-to-port communication. However, one aspect of the invention is to enable users to engage in P2P communication whether or not they are located behind a firewall. In one embodiment, this may accomplished by having the P2P application 170 that is running on the client system 310 open an outbound port on the firewall 320 and then connect to the firewall server 130. Similarly, the P2P application 170 that is running on the client system 330 can open an outbound port on the firewall 340 and also connect to the firewall server 130. The firewall server 130 may, in turn, leave the port open for use by those users who are part of the private networks for client system 310 and/or 330. In one embodiment, the firewall server 130 may also notify other users who are approved to communicate/access client systems 310 and/or 330 that these users are available for P2P communication. In another embodiment, the P2P application 170 running on either of client system 310 and 330 may directly notify other P2P users in the user's defined community who also have P2P applications running that the user is available.

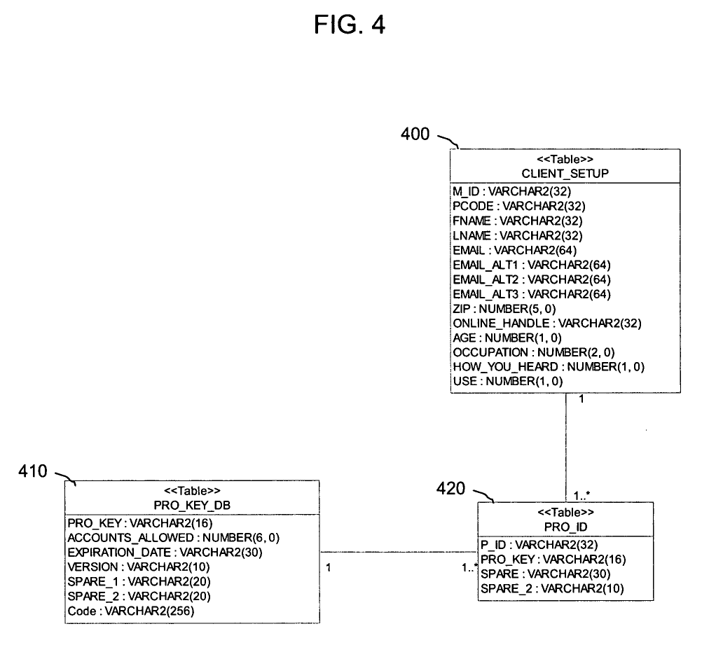

As previously mentioned, one aspect of the invention is to ensure that users are communicating with the expected party using uniquely identifying PKIs. In one embodiment, the identity of a peer is assured by use of a setup server (e.g., setup server 110) where administrators issue license keys to end users and pre-register those users. During a pre-registration process, the setup server may be accessed to generate a private license key that will be used to secure and encrypt all subsequent communications from one user to another. To that end, FIG. 4 depicts specific tables in a relational database of the setup server and how they are associated to one another during a pre-registration period. In one embodiment, table 400 contains user setup information that is provided by the user. This setup table (i.e., table 400) may contain such information as username, password, email address, zip code, age, occupation, etc. Once entered, this setup information may then be related to a corresponding unique license key that is store in a key table, such as table 410. The relationship between the key table and setup table may then be maintained in a separate association table, such as table 420.

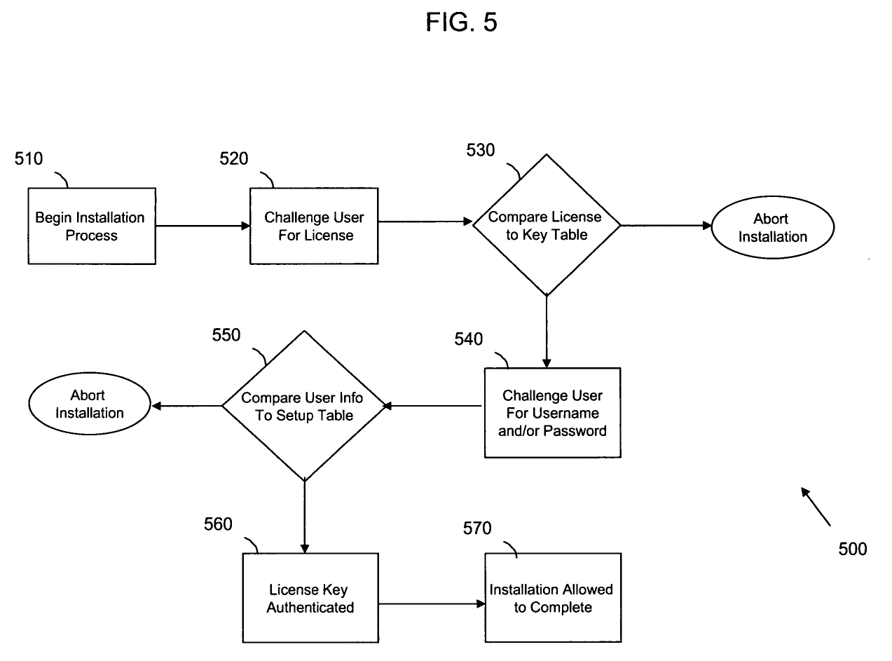

At the completion of the pre-registration period, a database will exist that contains a permanent association between a user's identity and their license key (stored in table 420, for example). In one embodiment, the user will have already been authenticated by the P2P administrator using any number of authentication methods to validate the identity of the person receiving the generated license key (e.g., company ID, passport, fingerprint, retinal scan, etc.) Referring now to FIG. 5, depicted is one embodiment of a process 500 for installing a P2P client (e.g., client-side P2P application 180) following the pre-registration process of FIG. 4. The installation process 500 is initiated by the user at block 510. Before the installation process will be permitted to continue, the user is challenged to provide their license key at block 520. The provided license key is then compared to those stored in a key table (e.g., table 410) at block 530. If there is no match for the comparison operation of block 530, process 500 will abort and installation of the P2P client application will not be permitted. If, on the other hand, there is a match at block 530, process 500 will process to block 540 where the user may then be challenged for a username and/or password.

A comparison of the provided username to a stored value may then be performed at block 550. However, in this case the username provided will be compared to the username that corresponds to the license key that was previously provided (i.e., from block 520). In one embodiment, the previously provided license key (from block 520) will be used to perform a lookup in an association table (e.g., table 420), the result of which can then be used to perform a lookup in a setup table (e.g., table 410) containing the actual username that is associated with the given license key.

In addition to providing and comparing usernames, process 500 may also challenge the user at block 540 for the password that is assigned to the provided username. As with the username, the provided password will have to match the password that corresponds to both the provided license key, as well as the provided username.

If there is no match for the comparison operation of block 550, process 500 will abort and installation of the P2P client application will not be permitted. If, on the other hand, there is a match at block 550, process 500 will process to block 560 where the license key will be authenticated by the setup server. It should be noted that in one embodiment, successfully using the license key for the first time will cause it to be removed from the available pool of license keys. Thereafter, the installation process of the P2P client will be permitted to continue (block 570).

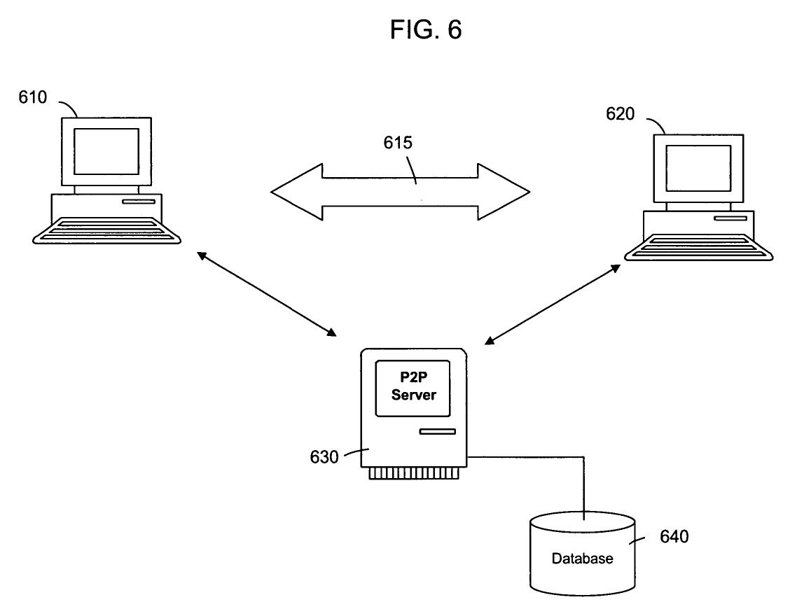

FIG. 6 depicts a system-level diagram of one embodiment of the interaction between a P2P server and two exemplary P2P clients. Communication 615 between two P2P community users 610 and 620 begins when one of them issues a request to communicate with the other. Each user 610 and 620 will be required to first register with the P2P server 630 by passing its license key, username and password. In one embodiment, this operation is performed using a client-side API, such as client-side P2P application 180 executing on each of user computers 610 and 620. After a successful registration, the P2P server 630 may assign a session PKI key to each of the users 610 and 620 to be used for all subsequent communications. An attempt by either user 610 or user 620 to send a communication 615 to the other will cause their respective PKI keys to be passed to the other. The recipient user (i.e., the one to whom the communication is directed) may then authenticate the received PKI key against the previously authenticated or registered key stored in database 640 of the P2P server 630, thereby ensuring the communication is in fact coming from the correct person. Each subsequent communication 615 from either user 610 or user 620 for a given session will similarly be authenticated by comparing their respective PKI keys with the ones stored by server 630.

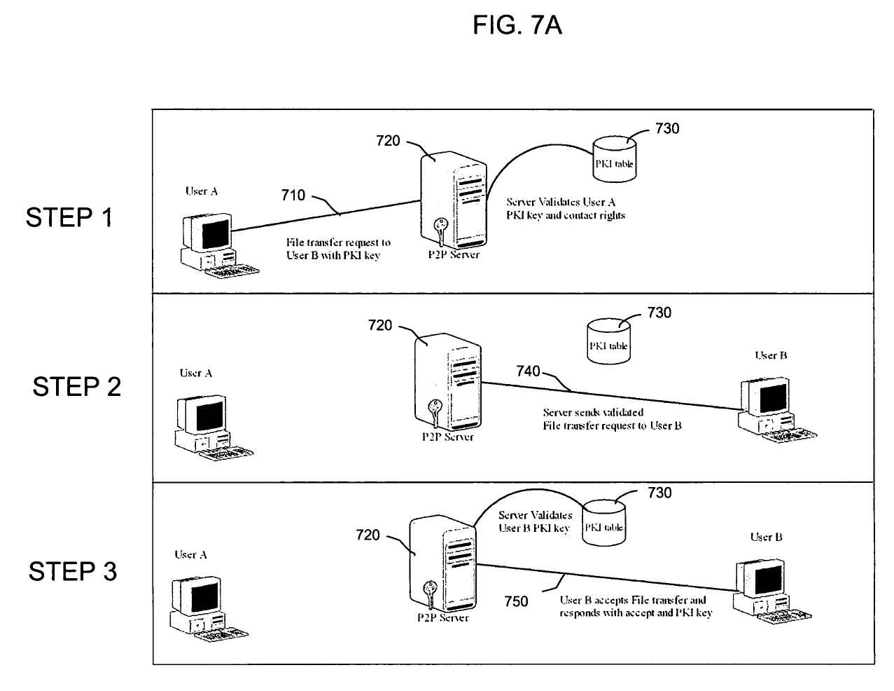

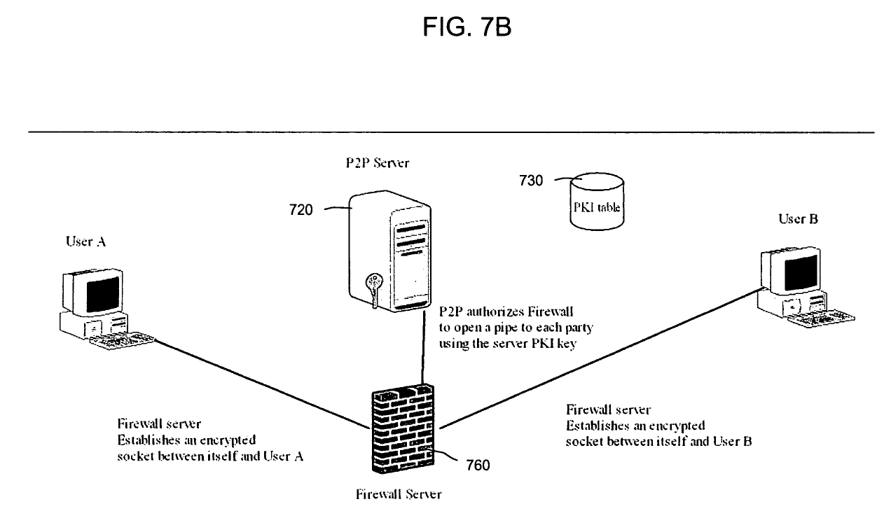

For users and/or organizations requiring tighter security, a P2P firewall server (e.g., P2P firewall server 130) can be set to operate in an active mode, during which users will not be allowed to connect directly to one another as was described previously with reference to FIG. 6. Rather, while in this mode all communications are relayed through a P2P firewall server, or a firewall module of a P2P server. To that end, FIG. 7A depicts one embodiment of how communication through a P2P firewall server may be initiated. As shown, in Step I User A submits a file transfer request 710 to a P2P server 720 (e.g., setup server 110) requesting that data be sent to another client. In response, the P2P server 720 authenticates User A's PKI session key, as previously described. Once User A's key has been validated against the key that was stored in table 730 during the pre-registration process, the process proceeds to Step 2. In Step 2, the P2P setup server 720 sends a validated file transfer request 740 to the destination P2P client, which in this case is denoted as User B. In Step 3, User B responds to the request 740 by sending its PKI session key as well (transmission 750). User B's PKI session key may then be validated by the P2P server 720 against the key previously stored in PKI session key table 730 (e.g., during the pre-registration process).

At this point, the P2P server 720 may authorize a port to be opened in a P2P firewall server (e.g., firewall server 130), as shown in FIG. 7B. That is, the P2P firewall server 760 may open an encrypted socket between itself and each party (i.e., User A and User B). Information may then be relayed through the firewall server 760 thereby keeping the parties from directly communicating with each other, yet ensuring that the parties are who they claim to be.

In another embodiment, the firewall server 760 may enable linking to other security-based software, or provide additional security functionality itself. For example, real-time anti-virus scanning of file transfers may be provided by or enabled through the firewall server 760. Similarly, global logging of transactions between peers, or content control/moderation may also be provided.

When implemented in software, the elements of the invention are essentially the code segments to perform the necessary tasks. The program or code segments can be stored in a processor readable medium or transmitted by a computer data signal embodied in a carrier wave over a transmission medium or communication link. Processor readable medium may include any medium that can store or transfer information. Examples of the processor readable medium include an electronic circuit, a semiconductor memory device, a ROM, a flash memory or other non-volatile memory, a floppy diskette, a CD-ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art. Trademarks and copyrights referred to herein are the property of their respective owners.

What is claimed is:

1. A method for authenticating a peer-to-peer (P2P) communication from an originating user intended for a destination user comprising the acts of:
pre-registering said originating user, wherein said pre-registering includes receiving first user information for said originating user and assigning said originating user a first digital license key;
receiving a request to send said P2P communication to the destination user, wherein said request is accompanied by second user information and a second digital license key;
comparing the second user information and second digital license key in said request to said first user information and first digital license key stored during said pre-registering, and if there is a match
assigning a session key to said originating user usable by the destination user to authenticate the P2P communication.

2. The method of claim 1, wherein said pre-registering comprises:
storing said first user information in a first table, wherein said first table includes a plurality of user information entries;
storing the first digital license key in a second table, wherein said second table includes a plurality of license key entries;
associating said first user information with said first digital license key; and
storing association information based on said associating step in a third table.

3. The method of claim 2, wherein said association information is usable to lookup one of said plurality of user information entries given a corresponding one of said plurality of license key entries.

4. The method of claim 2, wherein comparing the second user information and second digital license key comprises:
determining if said second digital license key matches the first digital license key stored in the second table, and if so;
determining if said second user information matches the first user information stored in the first table, and if so;
assigning the session key to said originating user.

5. The method of claim 1, wherein said session key is a public key infrastructure value uniquely identifying subsequent communications from said first user.

6. The method of claim 1, further comprising:
receiving the P2P communication and an unauthenticated session key from the originating user;
comparing the unauthenticated session key to a previously stored session key for the originating user, and if there is a match
sending the P2P communication to the destination user.

7. The method of claim 1, further comprising:
receiving a second unauthenticated session key from the destination user;
comparing the second unauthenticated session key to a corresponding stored session key for the destination user, and if there is a match
allowing said destination user to send a second P2P communication to said originating user.

8. A system for authenticating a peer-to-peer (P2P) communication from an originating user intended for a destination user comprising:
a network accessible by said originating user and destination user;
a P2P server coupled to the network, wherein the P2P server is to execute computer program instruction sequences to cause the server to,
pre-register the originating user by receiving first user information for the originating user and assigning the originating user a first digital license key;
receive a request to send said P2P communication to the destination user,
receive second user information and a second digital license key in connection with said request;
compare the second user information and second digital license key to said first user information and first digital license key stored during said pre-registering, and if there is a match
assign a session key to said originating for authenticating said P2P communication.

9. The system of claim 8, wherein to pre-register said originating user, said server is to,
store said first user information in a first table, wherein said first table includes a plurality of user information entries;
store the first digital license key in a second table, wherein said second table includes a plurality of license key entries;
associate said first user information with said first digital license key; and
store association information based on said associating step in a third table.

10. The system of claim 9, wherein said association information is usable to lookup one of said plurality of user information entries given a corresponding one of said plurality of license key entries.

11. The system of claim 9, wherein to compare the second user information and second digital license key to the first user information and first digital license key, said server is to,
determine if the second digital license key matches the first digital license key stored in the second table, and if so;
determine if the second user information matches the first user information stored in the first table, and if so;
assign the session key to the originating user.

12. The system of claim 8, wherein said session key is a public key infrastructure value uniquely identifying subsequent communications from said first user.

13. The system of claim 8, wherein said server is further to execute program instruction sequences to cause the server to,
receive the P2P communication and an unauthenticated session key from the originating user;
compare the unauthenticated session key to a previously stored session key for the originating user, and if there is a match
send the P2P communication to the destination user.

14. The method of claim 1, wherein said server is further to execute program instruction sequences to cause the server to,
receive a second unauthenticated session key from the destination user;
compare the second unauthenticated session key to a corresponding stored session key for the destination user, and if there is a match
allow said destination user to send a second P2P communication to said originating user.

15. A method for providing peer-to-peer (P2P) communication from an originating user to a destination user comprising the acts of:
requesting initial user information from said originating user;
assigning said originating user a first digital license key;
storing said initial user information and first digital license key;
receiving a request to send said P2P communication to the destination user;
receiving second user information and a second digital license key from the originating user;
comparing the second user information and second digital license key to said first user information and first digital license key, and if there is a match
assigning said originating user a session key for said P2P communication.

16. The method of claim 15, wherein said session key is a public key infrastructure value uniquely identifying subsequent communications from said first user.

17. The method of claim 15, further comprising:
receiving an authentication request from the destination user for the P2P communication, said authentication request including an unauthenticated session key pass to the destination user from the originating user;
comparing the unauthenticated session key to the previously assigned session key for the originating user, and if there is a match
sending an authentication acknowledgment to the destination user for the P2P communication.

18. The method of claim 15, further comprising:
receiving a second unauthenticated session key from the destination user;
comparing the second unauthenticated session key to a corresponding previously assigned session key for the destination user, and if there is a match
authenticating a second P2P communication from said destination user.

19. The method of claim 15, wherein said session key is a public key infrastructure value uniquely identifying said originating user.

20. The method of claim 15, further comprising:
opening a first encrypted socket between a firewall server and the originating user;
opening a second encrypted socket between a firewall server and the destination user; and
routing said P2P communication through said first and second sockets.
